(19) United States
(12) Patent Application Publication
(10) Pub. No.: US 2025/0033381 A1
(43) Pub. Date: Jan. 30, 2025

(54) FEEDING APPARATUS AND IMAGE FORMING APPARATUS

(71) Applicant: BROTHER KOGYO KABUSHIKI KAISHA, Nagoya (JP)

(72) Inventors: HIKARU TAMURA, Okazaki (JP); YUKI TSUJIMURA, Konan (JP)

(73) Assignee: BROTHER KOGYO KABUSHIKI KAISHA, Nagoya (JP)

(21) Appl. No.: 18/785,089

(22) Filed: Jul. 26, 2024

(30) Foreign Application Priority Data
Jul. 28, 2023 (JP) 2023-123769

(51) Int. Cl. B41J 11/00; B41J 2/175; B41J 15/04; B41J 29/13; B65H 16/02; B65H 20/02

(52) U.S. Cl. CPC B41J 11/0075; B41J 2/17566; B41J 15/042; B41J 15/044; B41J 15/046; B41J 29/13; B65H 16/028; B65H 20/02

(57) ABSTRACT

There is provided a feeding apparatus including: a casing; a tray having a roll accommodating part configured to accommodate a roll in which a belt-shaped medium is rolled, the tray being configured to be moved between an attached position and a drawn-out position in a direction crossing an up-down direction and crossing a first direction, the first direction being a direction of an axis of the roll accommodated in the roll accommodating part; a feeder configured to feed the belt-shaped medium unrolled from the roll accommodated in the roll accommodating part of the tray in the attached position; and a roll-remaining amount display disposed on an outer surface of the tray and configured to display a remaining amount of the roll accommodated in the roll accommodating part.

### REFERENCE TO RELATED APPLICATIONS

This application claims priority from Japanese Patent Application No. 2023-123769 filed on Jul. 28, 2023. The entire content of the priority application is incorporated herein by reference.

### BACKGROUND ART

A sheet feeding apparatus (feeding apparatus) which includes a facsimile main body (casing) and a cassette (tray) which is detachably attached with respect to the facsimile main body (casing) is known. The cassette may have a placement part (first accommodating part) for a roll sheet (roll, roll body) and a placement part (second accommodating part) for a cut sheet (a sheet-like medium). The cassette may be movable with respect to the facsimile main body in a direction crossing the up-down direction and crossing a direction in which an axis of the roll sheet extends.

### SUMMARY

In the sheet feeding device described above, in order for a user to check the remaining amount of the roll sheet (roll, roll body), the user needs to draw the cassette (tray) out of the facsimile main body (casing) and visually check the roll sheet.

An object of the present disclosure is to provide a feeding apparatus and an image forming apparatus in each of which a remaining amount of a roll can be easily checked.

According to a first aspect of the present disclosure, there is provided a feeding apparatus including:
a casing;
a tray having a roll accommodating part configured to accommodate a roll in which a belt-shaped medium is rolled, the tray being configured to be moved between an attached position at which the tray is attached to the casing and a drawn-out position at which the tray is drawn out of the casing in a direction crossing an up-down direction and crossing a first direction, the first direction being a direction of an axis of the roll accommodated in the roll accommodating part;
a feeder configured to feed the belt-shaped medium unrolled from the roll accommodated in the roll accommodating part of the tray in the attached position; and
a roll-remaining amount display disposed on an outer surface of the tray and configured to display a remaining amount of the roll accommodated in the roll accommodating part.

According to a second aspect of the present disclosure, there is provided a feeding apparatus including:
a casing;
a tray having a roll accommodating part configured to accommodate a roll in which a belt-shaped medium is rolled, and a sheet accommodating part configured to accommodate a plurality of sheet media being stacked, the tray being configured to move relative to the casing;
the feeder configured to feed a sheet medium of the plurality of sheet media accommodated in the tray;
a roll-remaining amount display disposed on an outer surface of the tray and configured to display a remaining amount of the roll accommodated in the roll accommodating part; and
a sheet-remaining amount display disposed on an outer surface of the tray and configured to display a remaining amount of the plurality of sheet media accommodated in the sheet accommodating part.

According to the present disclosure, the remaining amount of a roll can be easily checked via a roll-remaining amount display disposed on an outer surface of a tray, without drawing the tray out of a casing.

### BRIEF DESCRIPTION OF DRAWINGS

FIG. 1 is a perspective view of a multi-functional peripheral.

FIG. 2 is a view depicting an inside of a casing of the multi-functional peripheral of FIG. 1, depicting a state that a roll is accommodated in a sheet feed tray.

FIG. 3 is a view depicting the inside of the casing of the multi-functional peripheral of FIG. 1, depicting a state that cut sheets are accommodated in the sheet feed tray.

FIG. 4 is a view depicting a range from a full load position to an empty load position of each of the roll and the cut sheets in the sheet feed tray of FIG. 1.

FIG. 5 is a plan view of the sheet feed tray of FIG. 1.

FIG. 6A is a perspective view depicting a first liquid accommodating part of the multi-functional peripheral of FIG. 1. FIG. 6B is a perspective view depicting a second liquid accommodating part of the multifunction peripheral of FIG. 1.

FIG. 7 is a perspective view depicting a roll-remaining amount display part and a roll accommodating part.

FIG. 8 is a front view of a multi-functional peripheral.

FIG. 9 is a view depicting a roll-remaining amount display part.

### DESCRIPTION

### Embodiments

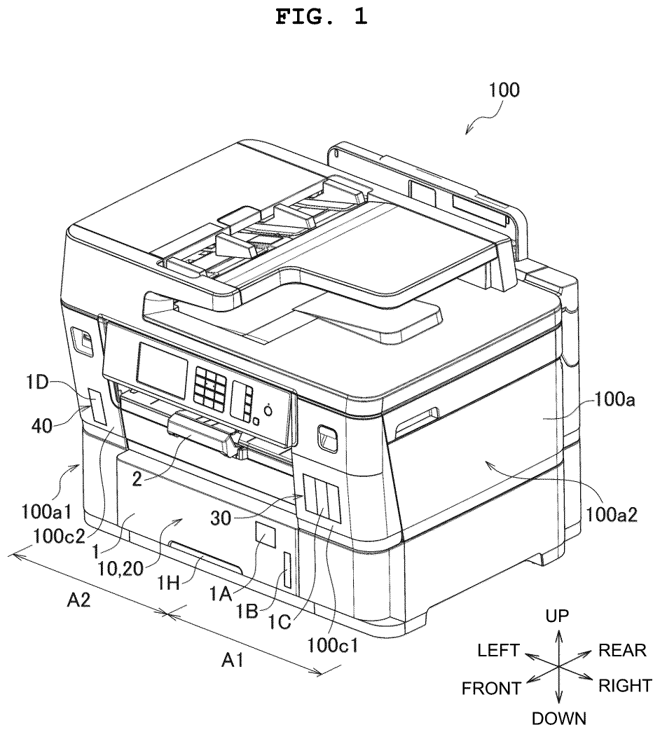

A multi-functional peripheral 100 depicted in FIG. 1 is the first embodiment of a “feeding apparatus” according to the present disclosure. The multi-functional peripheral 100 includes a casing 100a, a sheet feed tray 1, and a sheet discharge tray 2. The sheet feed tray 1 is an example of a “tray”.

The sheet feed tray 1 is movable in the front-rear direction with respect to the casing 100a, and is capable of taking an attached position (see FIGS. 1 to 3) at which the sheet feed tray 1 is attached to the casing 100a, and a drawn-out position (not depicted) at which the sheet feed tray is drawn out of the casing 100a and which is in front of the attached position.

A holding part (handle) 1H is disposed in a substantial center in the left-right direction of the front surface of the sheet feed tray 1. The holding part 1H is constructed of a recess. A user can move the sheet feed tray 1 frontward with respect to the casing 100a while holding the holding part 1H to thereby move the sheet feed tray 1 from the attached position to the pulled-out position.

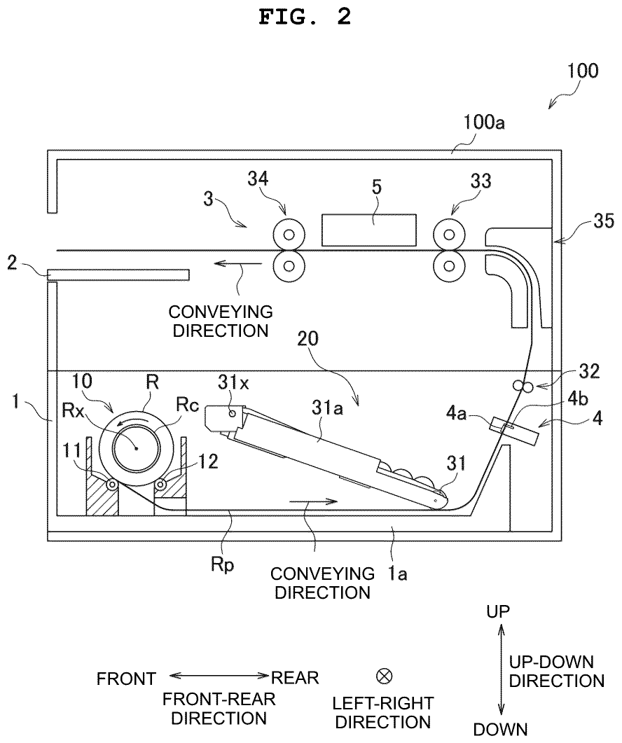

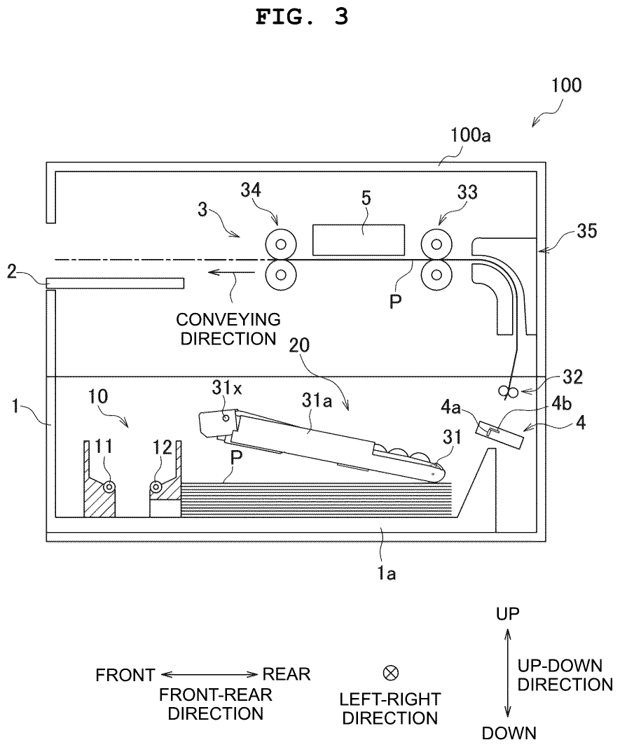

The sheet feed tray 1 has a roll accommodating part 10 (see FIG. 2) capable of accommodating a roll (roll body) R, and a cut sheet accommodating part 20 (see FIG. 3, an example of a “sheet accommodating part”) capable of accommodating a plurality of stacked cut sheets P. The roll accommodating part 10 and the cut sheet accommodating part 20 are aligned in the front-rear direction (a direction in which the sheet feed tray 1 moves with respect to the casing 100a).

As depicted in FIG. 2, the roll R is constructed of a long (belt-shaped) roll sheet Rp rolled (wound) in a roll shape around the outer circumferential surface of a cylindrical core member Rc. The roll R is accommodated in the roll accommodating part 10 in a state that an axis (shaft) Rx of the core member Rc extends in the left-right direction.

The roll sheet Rp is an example of a “belt-shaped medium”. Each of the cut sheets P is an example of a “sheet medium”. Note that the wording of “belt-shaped medium” means an elongated medium having a length, for example, greater than a length of a long side of a “sheet medium”.

As depicted in FIGS. 2 and 3, the multi-functional peripheral 100 further includes a conveyer 3, a cutting part 4, and a head 5 which are disposed inside the casing 100a.

Two rollers 11 and 12 constituting the conveyer 3 are disposed at the bottom of the roll accommodating part 10. Each of the two rollers 11 and 12 is rotatable about an axis extending in the left-right direction. In a case where the roll R is accommodated in the roll accommodating part 10, the outer peripheral surface of a lower part of the roll R is supported by the two rollers 11 and 12.

The conveyer 3 is configured to selectively convey (feed) the roll sheet Rp unrolled (unwound) from the roll R accommodated in the roll accommodating part 10, and an uppermost cut sheet P among the plurality of cut sheets P accommodated in the cut sheet accommodating part 20, in the conveying direction from the sheet feed tray 1 to the sheet discharge tray 2. The conveyer 3 is an example, of a “feeder (feeding mechanism)”.

The conveyer 3 includes the above-described two rollers 11 and 12, a feeding roller 31, roller pairs 32 to 34, and a guide 35.

The feeding roller 31 is rotatably supported at a forward end of the arm 31a. The arm 31a has the forward end which supports the feeding roller 31 and a base end in which a shaft 31x is disposed. The shaft 31x is supported by the casing 100a. The arm 31a is swingable with respect to the casing 100a, with the shaft 31x as the center of the swinging motion. The arm 31a is biased by a spring or the like in a direction in which the feeding roller 31 comes into contact with the bottom wall 1a of the sheet feed tray 1.

Each of the roller pairs 32 to 34 includes a driving roller and a driven roller which rotates together with the driving roller. In the conveyer 3, the feeding roller 31 and the driving roller of each of the roller pairs 32 to 34 are rotated by the drive of a conveying motor (not depicted).

The guide 35 is disposed between the roller pair 32 and the roller pair 33 in the conveying direction. The guide 35 has a pair of members between which a conveying route of the roll sheet Rp or the cut sheets P is interposed.

As depicted in FIG. 2, in a case where the conveying motor is driven in a state that the roll R is accommodated in the roll accommodating part 10, the feeding roller 31 rotates, thereby causing the roll sheet Rp unrolled from the roll R to be fed rearward. Consequently, the roll R rotates in a direction indicated by the arrow, thereby causing rollers 11 and 12 to rotate. The roll sheet Rp is fed to a location above the sheet feed tray 1 by the feeding roller 31, and the roll sheet Rp is further conveyed to the sheet discharge tray 2 by the roller pairs 32 to 34 each of which rotates while nipping the roll sheet Rp.

The cutting part 4 is disposed between the feeding roller 31 and the roller pair 32 in the conveying direction. The cutting part 4 includes a fixed blade 4a extending in the left-right direction and a disc-shaped rotary blade 4b disposed at a location at which the rotary blade 4b contacts the fixed blade 4a. The rotary blade 4b moves in the left-right direction by the drive of a cutting motor (not depicted). This causes the roll sheet Rp to be cut in the left-right direction.

As depicted in FIG. 3, in a case where the conveying motor is driven in a state that the plurality of cut sheets P are accommodated in the cut sheet accommodating part 20, the uppermost cut sheet P among the plurality of cut sheets P is fed to the location above the sheet feed tray 1 by the feeding roller 31, and the uppermost cut sheet P is further conveyed to the sheet discharge tray 2 by the roller pairs 32 to 34 each of which rotates while nipping the cut sheet P.

The head 5 is disposed between the roller pair 33 and the roller pair 34 in the conveying direction, and has a plurality of nozzles (not depicted) which are open in the lower surface of the head 5. The head 5 may be either of the line system which ejects an ink from the nozzles in a state that the position of the head 5 is fixed, or of the serial system which ejects the ink from the nozzles while moving in the left-right direction. The head 5 ejects the ink from the nozzles in a case where the roll sheet Rp or cut sheet P conveyed by the conveyer 3 passes at a location below the head 5, thereby recording an image on the roll sheet Rp or cut sheet P.

The sheet discharge tray 2 is positioned above the sheet feed tray 1 and is fixed with respect to the casing 100a.

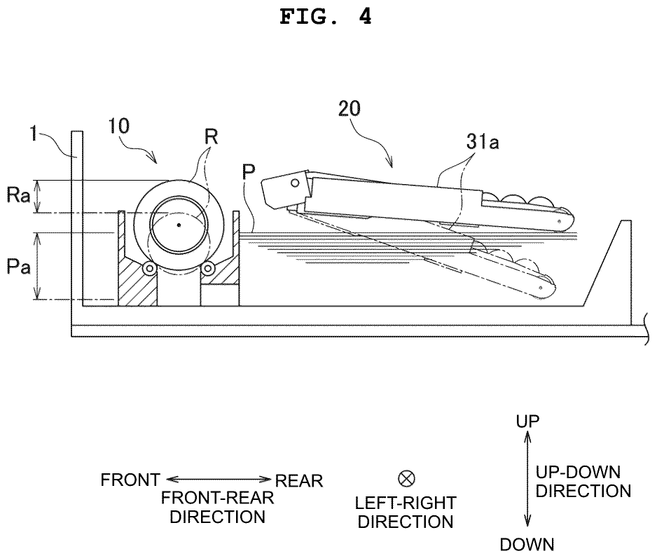

As depicted in FIG. 4, a range Ra from a full load position to an empty load position of the roll R in the roll accommodating part 10 is positioned above a range Pa from a full load position to an empty load position of the cut sheet(s) P in the cut sheet accommodating part 20. More specifically, a lower end of the range Ra is positioned above an upper end of the range Pa. Note that in the present embodiment, the range Ra and the range Pa do not overlap in the up-down direction. However, the range Ra and the range Pa may overlap in the up-down direction. In the present specification, the phrase “the range Ra is positioned above the range Pa” means any aspect in which the lower end of the range Ra is positioned above the lower end of the range Pa, and the upper end of the range Ra is positioned above the upper end of the range Pa. In FIG. 4, the roll R located at the full load position is depicted by a solid line, and the roll R located at the empty load position is depicted by a dot-and-dash line. The arm 31a in a case where the cut sheet(s) P are located at the full load position is depicted by a solid line, and the arm 31a in a case where the cut sheet(s) P is located at the empty load position is depicted by a dot-and-dash line.

A roll-remaining amount displaying part 1A which displays a remaining amount (including zero) of the roll R accommodated in the roll accommodating part 10 and a cut sheet-remaining amount displaying part 1B which displays a remaining amount (including zero) of the cut sheet(s) P accommodated in the cut sheet accommodating part 20 are disposed on the front surface of the sheet feed tray 1. The front surface of the sheet feed tray 1 is a surface which is exposed to the outside in a state that the sheet feed tray 1 is attached to the casing 100a. The front surface of the sheet feed tray 1 is an example of an “outer surface of the tray”. The roll-remaining amount displaying part 1A is a rectangle which is elongated in the left-right direction, whereas the cut sheet-remaining amount displaying part 1B is a rectangle which is elongated in the up-down direction. That is, the roll-remaining amount displaying part 1A and the cut sheet-remaining amount displaying part 1B have mutually different shapes. More specifically, the roll-remaining amount displaying part 1A and the cut sheet-remaining amount displaying part 1B have shapes which are mutually different as seen in a direction (here, the front-rear direction) orthogonal to the surface on which each of the roll-remaining amount displaying part 1A and the cut sheet-remaining amount displaying part 1B is disposed.

The roll-remaining amount displaying part 1A and the cut-sheet-remaining amount displaying part 1B are located to the right with respect to the holding part 1H and are disposed, respectively, at positions which do not overlap with the holding part 1H as seen in the up-down direction.

Each of the roll-remaining amount displaying part 1A and the cut sheet-remaining amount displaying part 1B is made of a transparent member. For example, a wall constructing the front surface of the sheet feed tray 1 has through holes at positions each of which corresponds to one of the roll-remaining amount displaying part 1A and the cut sheet-remaining amount displaying part 1B, and the transparent member is fitted into each of the through holes. The user can visually check the remaining amount of the roll R via the roll-remaining amount displaying part 1A, and the user can visually check the remaining amount of the cut sheet(s) P via the cut sheet-remaining amount displaying part 1B.

The roll-remaining amount displaying part 1A is positioned above the cut sheet-remaining amount displaying part 1B. This is due to the configuration wherein the range Ra from the full load position to the empty load position of the roll R in the roll accommodating part 10 is positioned above the range Pa from the full load position to the empty load position of the cut sheet(s) P in the cut sheet accommodating part 20, as described above with reference to FIG. 4. More specifically, a lower end of the roll-remaining amount displaying part 1A is positioned above an upper end of the cut sheet-remaining amount displaying part 1B. Note that in the present embodiment, the roll-remaining amount displaying part 1A and the cut sheet-remaining amount displaying part 1B do not overlap in the up-down direction. However, the roll-remaining amount displaying part 1A and the cut sheet-remaining amount displaying part 1B may overlap in the up-down direction. In the present specification, the phrase “the roll-remaining amount displaying part 1A is positioned above the cut sheet-remaining amount displaying part 1B” means any aspect in which the lower end of the roll-remaining amount displaying part 1A is positioned above the lower end of the cut sheet-remaining amount displaying part 1B and the upper end of the roll-remaining amount displaying part 1A is positioned above the upper end of the cut sheet-remaining amount displaying part 1B.

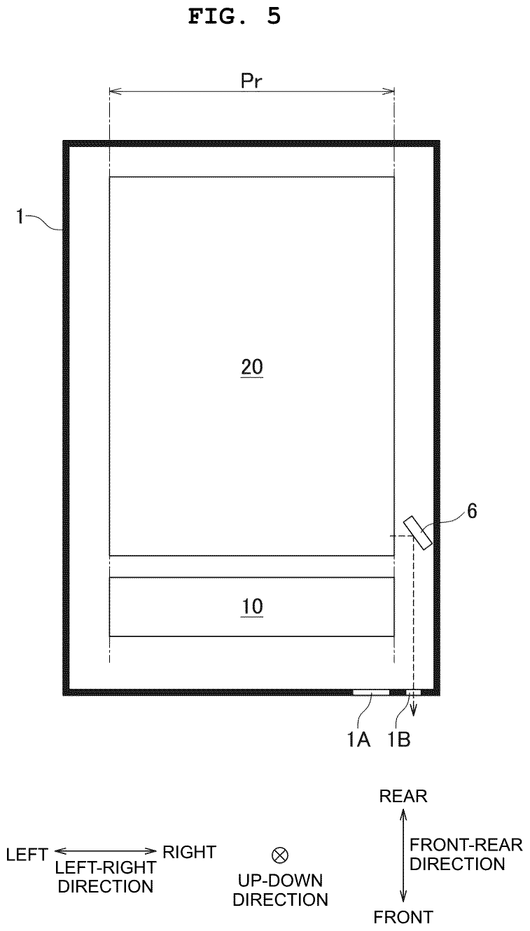

Note that since the roll accommodating part 10 is disposed between the cut sheet accommodating part 20 and the cut sheet-remaining amount displaying part 1B in the front-rear direction, direct visual checking of the cut sheet P via the cut sheet-remaining amount displaying part 1B may not be easy. Therefore, in this embodiment, as depicted in FIG. 5, the cut sheet-remaining amount displaying part 1B is disposed outside a conveying route Pr of the roll sheet Rp or the cut sheet P, and a mirror 6 is used, so that a mirror image of the cut sheet(s) P accommodated in the cut sheet accommodating part 20 can be seen via the cut sheet-remaining amount displaying part 1B.

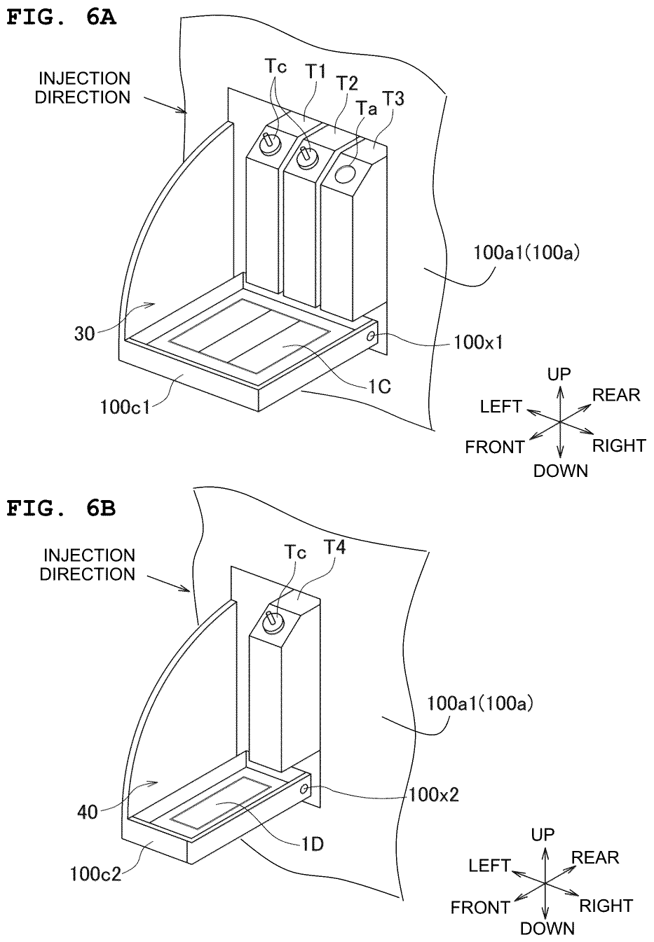

As depicted in FIG. 1, the casing 100a has a first ink accommodating part 30 (an example of a “first liquid accommodating part”) and a second ink accommodating part 40 (an example of a “second liquid accommodating part). The first ink accommodating part 30 can accommodate three ink tanks T1 to T3 (each of which is an example of a “liquid tank”; see FIG. 6A). The second ink accommodating part 40 can accommodate one ink tank T4 (see FIG. 6B).

Each of the ink tanks T1 to T4 is not of a replaceable type (cartridge type); rather, the ink can be injected into each of the ink tanks T1 to T4 (each of the ink tanks T1 to T4 can be replenished with the ink). The ink tanks T1 to T3 contain, respectively, cyan, magenta, and yellow inks. The ink tank T4 contains a black ink.

A first ink-remaining amount displaying part 1C (an example of a “first liquid-remaining amount display”) which displays the remaining amount (including zero) of each of the ink tanks T1 to T3 accommodated in the first ink accommodating part 30, and a second ink-remaining amount displaying part 1D (an example of a “second liquid-remaining amount display”) which displays the remaining amount (including zero) of the ink tank T4 accommodated in the second ink accommodating part 40 are disposed on a front surface 100a1 of the casing 100a.

The outer surface of the casing 100a has the front surface 100a1, a rear surface, left and right side surfaces 100a2, an upper surface, and a lower surface. The front surface 100a1 is an example of a “first surface”, and each of the side surfaces 100a2 is, for example, an example of a “second surface”. The first ink-remaining amount displaying part 1C and the second ink-remaining amount displaying part 1D are disposed on the front surface 100a1 of the casing 100a, and the roll-remaining amount displaying part 1A and the cut sheet-remaining amount displaying part 1B are disposed on the surface (the front surface of the sheet feed tray 1), of the sheet feed tray 1, which is along the front surface 100a1 of the casing 100a.

Note that a state that a certain surface is along another surface, for example, a state that the front surface of the sheet feed tray 1 is along the front surface 100a1 of the casing 100, etc., includes a state that the certain surface is flush with another surface, and further includes such a state that although a slight difference in height is present between the certain surface and another surface, the both surfaces may be considered as substantially constructing a continuous surface.

A surface constructed of the front surface 100a1 and the front surface of the sheet feed tray 1 has a first area A1 and a second area A2 by which the entire area of this surface is divided equally into two left and right halves. The roll-remaining amount displaying part 1A, the cut sheet-remaining amount displaying part 1B and the first ink-remaining amount displaying part 1C are disposed in the first area A1, and the second ink-remaining amount displaying part 1D is disposed in the second area A2.

A cover 100c1 and a cover 100c2 are disposed at positions corresponding, respectively, to the first ink accommodating part 30 and the second ink accommodating part 40.

The cover 100c1 is rotatable about a shaft 100x1 (see FIG. 6A) extending in the left-right direction. In a case where the cover 100c1 rotates about the shaft 100x1, the cover 100c1 thereby can be located at an open position depicted in FIG. 6A and a closed position depicted in FIG. 1. By locating the cover 100c1 at the open position, the first ink accommodating part 30 is exposed to the outside of the casing 100a. With this, the ink tanks T1 to T3 can be attached to the first ink accommodating part 30, the ink tanks T1 to T3 can be detached from the first ink accommodating part 30 to the outside of the casing 100a, and the ink can be injected into each of the ink tanks T1 to T3 accommodated in the first ink accommodating part 30.

The cover 100c2 is rotatable about a shaft 100x2 (see FIG. 6B) extending in the left-right direction. In a case where the cover 100c2 rotates about the shaft 100x2, the cover 100c2 thereby can be located at an open position depicted in FIG. 6B and a closed position depicted in FIG. 1. By locating the cover 100c2 at the open position, the second ink accommodating part 40 is exposed to the outside of the casing 100a. With this, the ink tank T4 can be attached to the second ink accommodating part 40, the ink tank T4 can be detached from the second ink accommodating part 40 to the outside of the casing 100a, and the ink can be injected into the ink tank T4 accommodated in the second ink accommodating part 40.

Each of the ink tanks T1 to T4 has an inlet port Ta and a cap Tc which closes the inlet port Ta. A surface of each of the ink tanks T1 to T4 in which the inlet port Ta is provided is an inclined surface which crosses both the up-down direction and the front-rear direction.

As depicted in FIGS. 6A and 6B, an injection direction in which the ink is injected into each of the ink tanks T1 to T4 accommodated in the first ink accommodating part 30 or the second ink accommodating part 40 is an inclined direction crossing both the up-down direction and the front-rear direction. The injection direction crosses the front surface of the sheet feed tray 1.

Each of the first ink-remaining amount displaying part 1C and the second ink-remaining amount displaying part 1D is made of a transparent member. For example, the cover 100c1 and the cover 100c2 have, respectively, through holes at positions each of which corresponds to one of the first ink-remaining amount displaying part 1C and the second ink-remaining amount displaying part 1D, and the transparent member is fitted into each of the through holes. The user can visually check the remaining amount of the ink in each of the ink tanks T1 to T3 via the first ink-remaining amount displaying part 1C, and the user can visually check the remaining amount of the ink in the ink tank T4 via the second ink-remaining amount displaying part 1D. Note that, each of the ink tanks T1 to T4 may be transparent, or may has any configuration which allows the user to visually check the remaining amount of the ink therein.

As described above, according to the present embodiment, the remaining amount of the roll R can be easily checked via the roll-remaining amount displaying part 1A disposed on the front surface (outer surface) of the sheet feed tray 1, without drawing the sheet feed tray 1 out of the casing 100a (see FIG. 1, FIG. 4, etc.).

Further, the remaining amount of cut sheet(s) P can also be easily checked via the cut sheet-remaining amount displaying part 1B disposed on the front surface (outer surface) of the sheet feed tray 1 (see FIG. 1, FIG. 4, etc.).

The range Ra from the full load position to the empty load position of the roll R in the roll accommodating part 10 is positioned above the range Pa from the full load position to the empty load position of the cut sheet(s) P in the cut sheet accommodating part 20 (see FIG. 4). The roll-remaining amount displaying part 1A is positioned above the cut sheet-remaining amount displaying part 1B (see FIG. 1). In this case, by disposing each of the roll-remaining amount displaying part 1A and the cut sheet-remaining amount displaying part 1B at the position corresponding to the object of display (that is, the roll R or the cut sheet P), the remaining amounts of the roll R and the remaining amount of the cut sheet P can be effectively checked via the roll-remaining amount displaying part 1A and the cut sheet-remaining amount displaying part 1B, respectively.

The roll-remaining amount displaying part 1A and the cut sheet-remaining amount displaying part 1B have the mutually different shapes (see FIG. 1). In this case, the user can easily know whether the remaining amount is the remaining amount of the roll R or the remaining amount of the cut sheet P.

The roll-remaining amount displaying part 1A is disposed on the surface along the front surface 100a1 of the casing 100a on which the first ink-remaining amount displaying part 1C is disposed (see FIG. 1). In this case, the user can also check the remaining amount of the roll R in a case where the user checks the remaining amounts in the ink tanks T1 to T3.

The roll-remaining amount displaying part 1A and the first ink-remaining amount displaying part 1C are disposed in the first area A1 (see FIG. 1). In this case, in a case where the remaining amounts in the ink tanks T1 to T3 are checked, the checking of the remaining amount of the roll R can also be easily executed.

The first ink-remaining amount displaying part 1C is disposed in the first area A1, whereas the second ink-remaining amount displaying part 1D is disposed in the second area A2 (see FIG. 1). In general, users tend to check the remaining amounts of the ink in the accommodating part (the first ink accommodating part 30) which accommodates more ink tanks more frequently than the remaining amount of the ink in the accommodating part (the second ink accommodating part 40) which accommodates fewer ink tank(s). According to the present embodiment, since the roll-remaining amount displaying part 1A is disposed in the same area as an area where the first ink-remaining amount displaying part 1C, which is checked more frequently, is disposed, the remaining amount of the roll R can also be checked more frequently.

The injection direction in which ink is injected into each of the ink tanks T1 to T3 accommodated in the first ink accommodating part 30 (see FIG. 6A) crosses the front surface of the sheet feed tray 1 in the state that the sheet feed tray 1 is attached to the casing 10. In this case, the user can easily check (visually check) the roll-remaining amount displaying part 1A in a case where the user performs an operation of injecting the ink(s) into the ink tank(s).

The roll-remaining amount displaying part 1A is disposed at the position which does not overlap with the holding part 1H as seen in the up-down direction (see FIG. 1). In this case, even in a state that the user holds the holding part 1H, the user can check the remaining amount of the roll R via (by visually checking) the roll-remaining amount displaying part 1A.

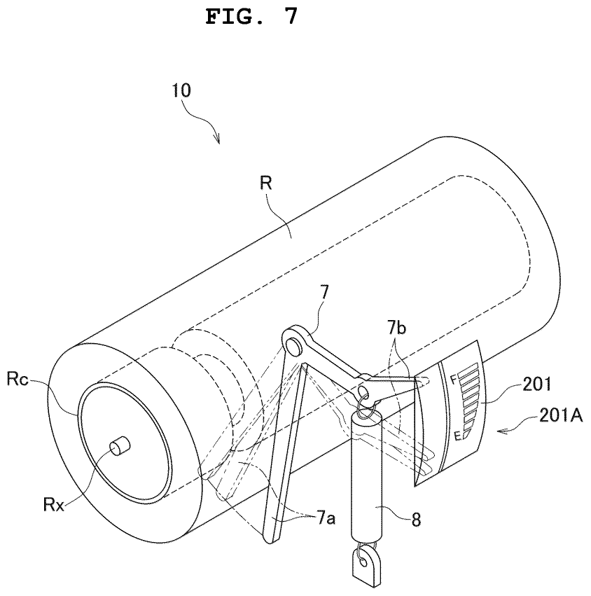

Next, the second embodiment of the present disclosure will be described with reference to FIG. 7.

The roll-remaining amount displaying part 1A in the first embodiment (see FIG. 1) has a flat shape, whereas a roll-remaining amount displaying part 201A (a transparent member 201 to be described later) in the second embodiment (see FIG. 7) has a curved shape.

The roll-remaining amount displaying part 1A in the first embodiment (see FIG. 1) is made of the transparent member which allows the remaining amount of the roll R to be visually checked from the outside. In contrast, the roll-remaining amount displaying part 201A in the second embodiment (see FIG. 7) has a transparent member 201 and a movable member 7. The movable member 7 is biased by a spring 8 in a direction of making contact with the outer circumferential surface of the roll R, and has an arm 7a which swings depending on the remaining amount of the roll R, and an interlocking part 7b which moves in the up-down direction in the inside of the transparent member 201 depending on the position of the arm 7a. The user can check the remaining amount of the roll R by visually checking the interlocking part 7b via the transparent member 201.

The roll R has a curved outer surface (see FIG. 4). According to the second embodiment, the transparent member 201 of the roll-remaining amount displaying part 201A has a curved shape to thereby allow the user to easily understand that the remaining amount displayed on the roll-remaining amount displaying part 201A is the remaining amount of the roll R, rather than the remaining amount of the cut sheet(s) P. Note that in the second embodiment, the transparent member 201 of the roll-remaining amount displaying part 201A is curved so that a central part in the up-down direction of the transparent member 201 protrudes with respect to both end parts in the up-down direction of the transparent member 201. That is, the aspect of the curvature of the transparent member 201 coincides with or is similar to the aspect of the curvature of the outer surface of the roll R accommodated in the roll accommodating part 10. Accordingly, the user can intuitively recognize that the remaining amount displayed on the roll-remaining amount displaying part 201A is the remaining amount of the roll R. The aspect of the curvature, however, is not limited to this.

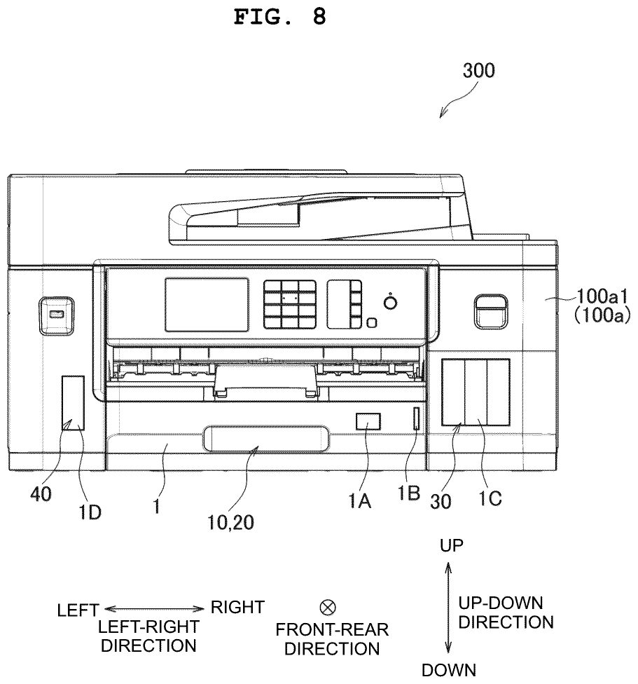

Next, the third embodiment of the present disclosure will be described with reference to FIG. 8.

In the first embodiment (see FIG. 1), the first ink-remaining amount displaying part 1C and the second ink-remaining amount displaying part 1D are positioned above the roll-remaining amount displaying part 1A, and the roll-remaining amount displaying part 1A is positioned above the cut sheet-remaining amount displaying part 1B.

In contrast, in a multi-function peripheral 300 of the third embodiment (see FIG. 8), the roll-remaining amount displaying part 1A, the cut sheet-remaining amount displaying part 1B, the first ink-remaining amount displaying part 1C and the second ink-remaining amount displaying part 1D are disposed, respectively, at substantially same positions in the up-down direction and are aligned in the left-right direction. The roll-remaining amount displaying part 1A, the cut sheet-remaining amount displaying part 1B, the first ink-remaining amount displaying part 1C and the second ink-remaining amount displaying part 1D are disposed, respectively, at mutually overlapping positions as seen in the left-right direction (that is, overlapped with one another in the up-down direction). The left-right direction is a direction along two sides, of the four sides of the front surface 100a1, which are along the left-right direction. The left-right direction is an example of an “aligning direction”.

According to the third embodiment, since the roll-remaining amount displaying part 1A and the first ink-remaining amount displaying part 1C are disposed, respectively, at the positions overlapping with each other as seen in the left-right direction, in a case where the user of the multi-functional peripheral 300 checks the remaining amounts in the ink tanks T1 to T3, the user can also check (visually check) the remaining amount of the roll R more easily.

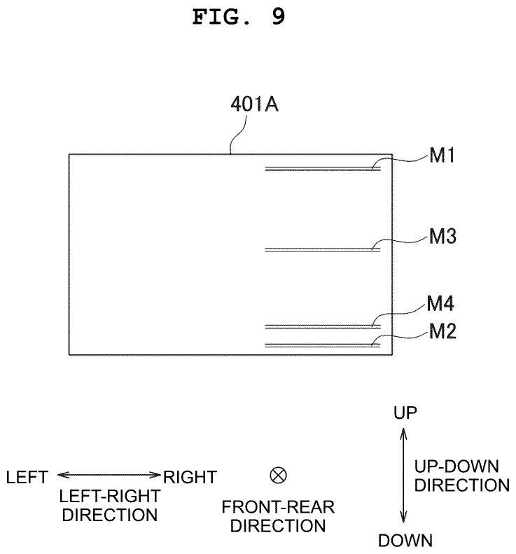

Next, the fourth embodiment of the present disclosure will be described with reference to FIG. 9.

In the first embodiment (see FIG. 1), the roll-remaining amount displaying part 1A does not include a scale of the remaining amount, whereas in the fourth embodiment (see FIG. 9), a roll-remaining amount displaying part 401A includes scales M1 to M4 of the remaining amount.

The scale M1 is disposed along a position of the outer circumferential surface of the roll R which is in a fully loaded state. The scale M2 is disposed along a position of the outer circumferential surface of the roll R which is in an empty loaded state. The scale M3 is disposed along a position of the outer circumferential surface of the roll R which is in an intermediate state between the fully loaded state and the empty loaded state. The scale M4 displays a so-called near empty, and is provided along a position of the outer circumferential surface of the roll R having a remaining amount of a predetermined length which is, for example, a length corresponding to ten A4 sheets.

In such a manner, the roll-remaining amount displaying part 401A of the fourth embodiment is configured to display the remaining amount in accordance with four stages. In this case, the user can easily grasp the remaining amount.

### (Modifications)

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

Although the roll accommodating part and the cut sheet accommodating part are aligned in the front-rear direction (the direction in which the tray moves with respect to the casing) in the above-described embodiments, the present disclosure is not limited to this. For example, the roll accommodating part and the cut sheet accommodating part may be aligned in the up-down direction (a direction orthogonal to the direction in which the tray moves with respect to the casing). Specifically, a first tray having a roll accommodating part and a second tray disposed below the first tray and having a cut sheet accommodating part may be disposed so that each of the first and second trays is movable with respect to the casing.

Each of the remaining amount displaying parts is not limited to the transparent member as in the first embodiment (see FIG. 1) or the combination of the transparent member and the movable member as in the second embodiment (see FIG. 7), and may be of any configuration which allows the user to directly or indirectly check the remaining amount.

Although the ink tank (liquid tank) is replenishable with the ink (liquid) in the above-described embodiments, the present disclosure is not limited to this. For example, the ink tank may be of a replaceable type (cartridge type). In the case of a replaceable ink tank, an attachment direction in which each of the ink tanks is attached to the first ink accommodating part may cross the outer surface on which the roll-remaining amount displaying part is disposed. For example, in a case where the attachment direction of the replaceable ink tank to the first liquid accommodating part is downward, the roll-remaining amount displaying part may be disposed on the upper surface (a surface orthogonal to the up-down direction) of the tray. A liquid tank accommodating any liquid such as a cleaning liquid may be used, instead of using the ink tank.

Although the outer surface on which the roll-remaining amount displaying part is disposed crosses the injection direction in the above-described embodiments, the outer surface may be orthogonal to the injection direction. For example, in the first embodiment, an inclined surface which crosses both the up-down direction and the front-rear direction may be disposed on the front surface of the sheet feed tray 1, and the roll-remaining amount displaying part 1A may be disposed on the inclined surface. In this case, the inclined surface is orthogonal to the injection direction (see FIGS. 6A and 6B).

The belt-shaped medium and the sheet-like medium are not limited to a paper sheet, and may be, for example, cloth, a resin member, etc.

The recording part is not limited to being of the liquid ejection system, and may be of a laser system, a thermal transfer system, or the like.

The feeding apparatus according to the present disclosure is not limited to the multi-functional peripheral, and may be a printer, a facsimile, a copying machine, or the like.

What is claimed is:

1. A feeding apparatus comprising:
a casing;
a tray having a roll accommodating part configured to accommodate a roll in which a belt-shaped medium is rolled, the tray being configured to be moved between an attached position at which the tray is attached to the casing and a drawn-out position at which the tray is drawn out of the casing in a direction crossing an up-down direction and crossing a first direction, the first direction being a direction of an axis of the roll accommodated in the roll accommodating part;
a feeder configured to feed the belt-shaped medium unrolled from the roll accommodated in the roll accommodating part of the tray in the attached position; and
a roll-remaining amount display disposed on an outer surface of the tray and configured to display a remaining amount of the roll accommodated in the roll accommodating part.

2. The feeding apparatus according to claim 1, wherein the roll-remaining amount display has a curved shape.

3. The feeding apparatus according to claim 2, wherein the tray has an arm including:
a first arm biased by a biasing member to make contact with an outer circumferential surface of the roll in the roll accommodating part; and
a second arm having a first end connected to the first arm and a second end, opposite to the first end, positioned in the roll-remaining amount display as seen in the direction in which the tray is moved between the attached position and the drawn-out position.

4. The feeding apparatus according to claim 1, wherein the casing has a first liquid accommodating part configured to accommodate a liquid tank,
the feeding apparatus further comprises a first liquid-remaining amount display disposed on an outer surface of the casing, the first liquid-remaining amount display being configured to display a remaining amount of a liquid in the liquid tank accommodated in the first liquid accommodating part, wherein:
the first liquid-remaining amount display is disposed on a first surface of the outer surface of the casing; and
in a state that the tray is in the attached position, the outer surface on which the roll-remaining amount display is disposed is positioned along the first surface.

5. The feeding apparatus according to claim 4, wherein in the state that the tray is in the attached position, both the roll-remaining amount display and the first liquid-remaining amount display are positioned on a first side in the first direction with respect to a center of the casing in the first direction.

6. The feeding apparatus according to claim 5, wherein the casing further has a second liquid accommodating part configured to accommodate a liquid tank, the first liquid accommodating part being configured to accommodate the liquid tank as many as a first number, the second liquid accommodating part being configured to accommodate the liquid tank as many as a second number, the first number being greater than the second number,
the feeding apparatus further comprises a second liquid-remaining amount display disposed on the outer surface of the casing and configured to display a remaining amount of a liquid in the liquid tank accommodated in the second liquid accommodating part, wherein
in the state that the tray is in the attached position, the second liquid-remaining amount display is positioned on a second side in the first direction, opposite to the first side, with respect to the center of the casing in the first direction.

7. The feeding apparatus according to claim 4, wherein in the state that the tray is in the attached position, the roll-remaining amount display and the first liquid-remaining amount display are aligned in the first direction and overlapped with one another in the up-down direction, or are aligned in the up-down direction and overlapped with one another in the first direction.

8. The feeding apparatus according to claim 4, wherein in the state that the tray is in the attached position, an injection direction in which the liquid is injected to the liquid tank accommodated in the first liquid accommodating part and/or an attachment direction in which the liquid tank is attached to the first liquid accommodating part cross/crosses the outer surface on which the roll-remaining amount display is disposed.

9. The feeding apparatus according to claim 1, wherein:
the tray has a handle; and
the roll-remaining amount display is disposed at a position different, in the first direction, from a position at which the handle is disposed.

10. The feeding apparatus according to claim 1, wherein the roll-remaining amount display is configured to display the remaining amount in accordance with three or more stages.

11. An image forming apparatus comprising:
the feeding apparatus as defined in claim 1; and
an image former configured to form an image on the belt-shaped medium fed by the feeder of the feeding apparatus.

12. A feeding apparatus comprising:
a casing;
a tray having a roll accommodating part configured to accommodate a roll in which a belt-shaped medium is rolled, and a sheet accommodating part configured to accommodate a plurality of sheet media being stacked, the tray being configured to move relative to the casing;
the feeder configured to feed a sheet medium of the plurality of sheet media accommodated in the tray;
a roll-remaining amount display disposed on an outer surface of the tray and configured to display a remaining amount of the roll accommodated in the roll accommodating part; and
a sheet-remaining amount display disposed on an outer surface of the tray and configured to display a remaining amount of the plurality of sheet media accommodated in the sheet accommodating part.

13. The feeding apparatus according to claim 12, wherein:
a range from a full load position to an empty load position of the roll in the roll accommodating part is positioned above a range from a full load position to an empty load position of the plurality of sheet media in the sheet accommodating part; and
the roll-remaining amount display is positioned above the sheet-remaining amount display.

14. The feeding apparatus according to claim 12, wherein a shape of the roll-remaining amount display and a shape of the sheet-remaining amount display are different from each other.

15. The feeding apparatus according to claim 12, wherein:
the sheet-remaining amount display is disposed on the outer surface on which the roll-remaining amount display is disposed;
the roll accommodating part is positioned between the outer surface of the tray on which the sheet-remaining amount display is disposed and the sheet accommodating part in a direction in which the tray is moved relative to the casing;
a distance in a first direction between the sheet-remaining amount display and a central part in the first direction of the outer surface of the tray is greater than a distance in the first direction between the roll-remaining amount display and the central part in the first direction of the outer surface of the tray, the first direction being a direction of an axis of the roll accommodated in the roll accommodating part; and
the tray has a mirror positioned so as to allow a user to visually check the plurality of sheet media accommodated in the sheet accommodating part via the sheet-remaining amount display.
